(19) United States
(12) Patent Application Publication
(10) Pub. No.: US 2025/0045755 A1
(43) Pub. Date: Feb. 6, 2025

(54) AUTHENTICATION PROTOCOL FOR PROVIDING REMOTE ACCESS TO SERVICE DEVICES TO FACILITATE SECURE TRANSACTIONS

(71) Applicant: Truist Bank, Charlotte, NC (US)

(72) Inventors: Sudhakar Swaminathan, Duluth, GA (US); Muthu Gopalakrishnan, Suwanee, GA (US); Ryan Loesch, Cumming, GA (US)

(73) Assignee: Truist Bank, Charlotte, NC (US)

(21) Appl. No.: 18/363,193

(22) Filed: Aug. 1, 2023

(51) Int. Cl. G06Q 20/40; G06Q 20/32; G06Q 20/38

(52) U.S. Cl. CPC G06Q 20/4014; G06Q 20/326; G06Q 20/3276; G06Q 20/3278; G06Q 20/3821

(57) ABSTRACT

A system can be provided that can initiate a step-up authentication protocol to facilitate secure transactions. For example, the system can include an Internet of Things (IoT) service device. The system can also include a computing environment, which can receive, from a mobile device, a request to perform a function of the IoT service device. The request can include first authentication credentials. The computing environment can further determine that the request satisfies requirements for the step-up authentication protocol and can initiate the step-up authentication protocol by transmitting an authentication request to the mobile device. As a result, the computing environment can receive the second authentication credentials and can authenticate a user of the mobile device based on the first and second authentication credentials. Additionally, the computing environment can transmit an application programming interface (API) call to the IoT service device to cause the IoT service to perform the function.

### TECHNICAL FIELD

The present disclosure relates generally to secure transactions and, more particularly (although not necessarily exclusively), to a step-up authentication protocol for providing remote access to services device to facilitate secure transactions between the service devices and user accounts.

### BACKGROUND

A service provider can resolve service events for users at a location associated with the service provider. For example, a user can wait in a queue at the location to have a service event resolved by authorized personnel. However, waiting in the queue can be time-consuming. Thus, it can be desirable to automate the service events, such as by implementing service devices at the location associated with the service provider. The users can interact with the service devices, such as automated teller machines (ATMs), to cause the service devices to perform functions (e.g., the service events). For example, the users can interact with the ATMs to cause the ATMs to withdraw funds, deposit funds, or perform other suitable service events.

Additionally, there can be security concerns with automating the service events. Current service devices can require that users input pin numbers or access cards to authenticate with the service device prior to the user requesting that the service device perform service events. The pin numbers and access cards, however, may be stolen and may not be sufficient for authenticating the user. Due to the security concerns, some service events may not be performed via the service devices. For example, the user may not be able to withdrawal of funds above a withdrawal limit via the ATMs. Therefore, there can be a need for improved security mechanisms for service devices.

### SUMMARY

A step-up authentication protocol can be implemented to provide remote access to services devices and facilitate secure transactions between the service devices and user accounts. For example, a system described herein can include a an Internet of Things (IoT) service device positioned in a location associated with a service provider. The system can also include a computing environment. The computing environment can be configured to control the service device by receiving, from a mobile device, a request to perform at least one function of the IoT service device. The request can include first authentication credentials for a user account associated with the service provider. The computing environment can further determine that the request satisfies at least one requirement of a step-up authentication protocol. In response to determining that the request satisfies the at least one requirement, the computing environment can transmit an authentication request for second authentication credentials to the mobile device. The computing device can then receive, from the mobile device, the second authentication credentials. The computing device can further authenticate a user of the mobile device based on the first authentication credentials and the second authentication credentials. In response to authenticating the user, the computing environment can transmit an application programming interface (API) call to the IoT service device to cause the IoT service device to perform the at least one function. The at least one function can involve a secure transaction between the IoT service device and the user account.

In another example, a computer-implemented method described herein can include receiving, from a mobile device, a request to perform at least one function of an IoT service device. The IoT service device can be positioned in a location associated with a service provider, and the request can include first authentication credentials for a user account associated with the service provider. The computer-implemented method can also include determining that the request satisfies at least one requirement of a step-up authentication protocol. In response to determining that the request satisfies the at least one requirement, the computer-implemented method can include transmitting an authentication request for second authentication credentials to the mobile device. Additionally, computer-implemented method can include receiving, from the mobile device, the second authentication credentials. The computer-implemented method can include authenticating a user of the mobile device based on the first authentication credentials and the second authentication credentials. In response to authenticating the user, the computer-implemented method can include transmitting an API call to the IoT service device to cause the IoT service device to perform the at least one function. The at least one function can involve a secure transaction between the IoT service device and the user account.

In an example, a non-transitory computer-readable medium can include instructions that are executable by a processor for causing the processor to perform operations including receiving, from a mobile device, a request to perform at least one function of an Internet of Things (IoT) service device. The IoT service device can be positioned in a location associated with a service provider, and the request can include first authentication credentials for a user account associated with the service provider. The operations can also include determining that the request satisfies at least one requirement for a step-up authentication protocol. In response to determining that the request satisfies the at least one requirement, the operations can include transmitting an authentication request for second authentication credentials to the mobile device. The operations can include receiving, from the mobile device, the second authentication credentials. Additionally, the operations can include authenticating a user of the mobile device based on the first authentication credentials and the second authentication credentials. In response to authenticating the user, the operations can include transmitting an API call to the IoT service device to cause the IoT service device to perform the at least one function. The at least one function can involve a secure transaction between the IoT service device and the user account.

### BRIEF DESCRIPTION OF THE DRAWINGS

FIG. 1 is a schematic of an example of an Internet of Things (IoT) service device environment according to some embodiments of the present disclosure.

FIG. 2 is a block diagram of an example of a computing environment for implementing a step-up authentication protocol to facilitate secure transactions between IoT service devices and user accounts according to some embodiments of the present disclosure.

FIG. 3 is a block diagram of an example of a computing device for implementing the step-up authentication protocol to facilitate secure transactions between IoT service devices and user accounts according to some embodiments of the present disclosure.

FIG. 4 is a flow chart of a process for implementing the step-up authentication protocol to facilitate secure transactions between IoT service devices and user accounts according to some embodiments of the present disclosure.

### DETAILED DESCRIPTION

Certain aspects and examples of the present disclosure relate to providing remote access to service devices to facilitate secure transactions between the service devices and user accounts. In some examples, the service devices can be IoT service devices. Examples of the service devices can include automated teller machines (ATMs), electronic funds transfer (EFT) terminals, teller cash recyclers (TCRs), check scanners, printers, or other suitable devices associated with a service provider (e.g., a financial institution). The IoT service devices can be service devices that are connected to a network, such as a local area network (LAN) or the internet. The IoT service devices can be in communication with a computing environment (e.g., a IoT computing platform), mobile devices, service devices, other IoT devices, etc. via the network. For example, the IoT service devices can receive requests to perform functions, receive requests for data, transmit data, or otherwise communicate with the IoT computing platform, the mobile devices, the service devices, the other IoT devices, etc. via the network.

In some examples, the IoT service devices can be situated within a location associated with the service provider and the remote access can be provided to mobile devices. In particular, the remote access may be provided to mobile devices associated with a service provider. For example, the mobile devices can be authorized mobile devices, such as those belonging to employees or other suitable authorized personnel for the service provider. Additionally, the mobile devices can be registered with the user accounts associated with the service provider or can be running a software application associated with the service provider.

To provide the remote access to the mobile devices, authentication of the mobile devices can be performed. In some examples, authenticating the mobile devices can include verifying that a mobile device is within a proximity of the IoT service device (e.g., within the location associated with the service provider), detecting that the mobile device is registered with the service provider, detecting that the mobile device is associated with a user account, or combination thereof. Additionally or alternatively, users of the mobile devices may be authenticated. For example, authenticating a user of the mobile device may include verifying that the user is associated with the user account, such as via authentication credentials, an answer to a security question, etc.

Due to the remote access, the mobile devices can transmit requests for the IoT service devices to perform one or more functions. The functions can involve the IoT service device performing a service event (e.g., a secure transaction) with respect to a user account associated with the service provider. In some examples, the requests may satisfy one or more requirements of a step-up authentication protocol. The requirements or rules of the step-up authentication protocol can define when to implement the step-up authentication protocol rather than a standard authentication process. For example, a request may be for an IoT service device to perform a highly secure function, such as withdrawing a large amount of funds. As a result of the request being for the highly secure function, the request may satisfy a requirement and the step-up authentication protocol may be automatically executed. The step-up authentication protocol can be a highly secure authentication process performed prior to the IoT services performing the functions. For example, execution of the step-up authentication protocol can include requesting more than one type of authentication from the user. In this way, the step-up authentication protocol can be more secure than the standard authentication process, which may only require one type of authentication from the user (e.g., a pin number).

Current systems can involve the user directly interacting with the service devices. For example, a service device can include a user interface with options for the functions. The user can select, via the user interface, an option to cause the service device to perform a function. Additionally, there can be security concerns with the current systems. For example, in the current systems, a pin number, an access card, or a combination thereof can be used to authenticate with the service device. The user may input the pin number or the access card, both of which may be associated with the user account, via the user interface. The service device can authenticate the user based on the pin number or the access card, and can, for example, withdraw funds from the user account. However, if for example, the pin number or the access card, are stolen, the service device may not be able to detect the security breach and may still perform the withdrawal of funds. Additionally, due to the security concerns with current systems, the functions that the service devices can perform may be limited. For example, the user may only be able to withdraw funds up to a withdraw limit (e.g., up to five hundred dollars) via the service device.

Examples of the present disclosure can overcome one or more of the above-mentioned problems via a computing environment that executes the step-up authentication protocol to authenticate users of mobile devices prior to causing the IoT service devices to perform the functions. In this way, the computing environment can facilitate secure interactions between the IoT service devices and the user accounts. For example, as part of a security breach, a user's authentication credentials for a user account can be stolen. Then, a request for an IoT service device to perform a function with respect to the user account may be transmitted with the authentication credentials. In response, the computing environment may authenticate the user based on the authentication credentials. But, for security purposes, the computing environment may execute the step-up authentication protocol by transmitting a request for additional authentication credentials to the mobile device. The additional authentication credentials may not be received or may be inaccurate due to the security breach. Additionally, the transmission of the request for additional authentication credentials may alert a user of a mobile device associated with the user account to the security breach. Thus, as a result of executing the step-up authentication protocol, the computing environment may detect the security breach and may not perform the requested function.

Additionally, due to the improved security of requiring multiple authentication credentials for certain requests, the computing environment may enable the IoT service device to perform highly secure service events, such as a withdrawal of funds above the withdrawal limit. In this way, service events that current systems may not have been permitted to perform can be automated. Additionally, due to the requests for the IoT service devices to perform functions being transmitted via the mobile devices, the secure interactions can be initiated in a contactless manner. Therefore, the IoT service devices may not include screens or other suitable mechanisms for user interaction.

Illustrative examples are given to introduce the reader to the general subject matter discussed herein and are not intended to limit the scope of the disclosed concepts. The following sections describe various additional features and examples with reference to the drawings in which like numerals indicate like elements, and directional descriptions are used to describe the illustrative aspects, but, like the illustrative aspects, should not be used to limit the present disclosure.

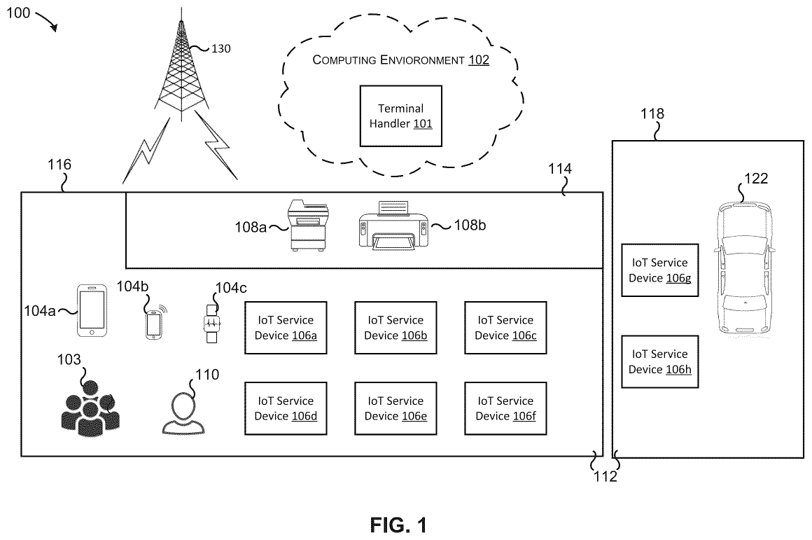

FIG. 1 is a schematic of an example of an IoT service device environment 100 according to one example of the present disclosure. The IoT service device environment 100 can be a location associated with a service provider. For example, the service provider can be a financial institution and the IoT service device environment 100 can be a branch location associated with the financial institution. The IoT service device environment 100 may include an indoor area 116 and an outdoor area 118. The IoT service device environment 100 may further include user accessible areas 112 and user inaccessible areas 114. The user accessible areas 112 can be accessed by one or more users 103 and by authorized personnel 110. Additionally, devices 104a-c and IoT service devices 106a-h can be located within the user accessible areas 112. The user inaccessible areas 114 can also be accessed by the authorized personnel 110, but may not be accessed by the users 103. In some examples, auxiliary devices 108a-b may be located in the user inaccessible areas 114 for use by the authorized personnel 110.

The devices 104a-c can include mobile devices such as tablets 104a, smartphones 104b, smart watches 104c, or the like. The devices 104a-c can be associated with the users 103 such as by being registered with user accounts belonging to the users 103. The devices 104a-c may also be associated with the authorized personnel 110, such as by being accessible via authentication credentials provided by the authorized personnel 110. The IoT service devices 106a-h can be devices for performing service events. The service events can be secure transactions performed with respect to user accounts, such as a withdrawal of funds from a user account, an update to data associated with a user account, etc. Thus, the IoT service devices 106a-h can include automated teller machines (ATMs), electronic funds transfer (EFT) terminals, teller cash recyclers (TCRs), check scanners, or other suitable devices associated with a service provider (e.g., a financial institution) and capable of performing service events. Additionally, the auxiliary devices 108a-b can include printers 108b, copiers 108a, or other suitable devices.

The IoT service device environment 100 may also include a computing environment 102. Examples of the computing environment 102 can include a cloud computing platform or an Internet of Things (IoT) computing platform. The devices 104a-c, the IoT service devices 106a-h, and the computing environment 102 can be communicatively coupled via a network 130. The network 130 may correspond to a Wide Area Networks (“WANs”), such as the Internet. In other examples, the network 130 may be a mobile telecommunication network, a short-range wireless network, or the like. The devices 104a-d and the IoT service devices 106a-h may also communicate with servers, web browsers, or user-side applications via the network 130 to establish communication sessions, request and receive web-based resources, or access other suitable features of software applications or web services.

Additionally, in some examples, a terminal handler 101 can be operating on the computing environment 102 for communicating with devices 104a-c, controlling IoT service devices 106a-h, or a combination thereof. The terminal handler 101 can manage each of the IoT service devices 106a-h. In some examples, the terminal handler 101 may also manage the auxiliary devices 108a-b. In some examples, the terminal handler 101 may detect issues the IoT service devices 106a-b or the auxiliary devices 108a-b and may further notify the authorized personnel 110, technician specialists, or the like of the issues. The terminal handler 101 can also receive requests from the devices 104a-c. The requests can be for any of the IoT service devices 106a-h or the auxiliary devices 108a-b to perform functions.

For example, a first IoT service device 106a may be an ATM and a request from a mobile device (e.g., tablet 104a) can be for the first IoT service device 106a to deposit a certain amount of funds into a user account. The terminal handler 101 may grant or deny the request based on an authentication process performed by a user of the mobile device. The terminal handler 101 may further detect that the request satisfies one or more requirements of a step-up authentication protocol. For example, the certain amount of funds may exceed a fund threshold included in the requirements. As a result, the terminal handler 101 can initiate the step-up authentication protocol by transmitting a request for the user to perform an additional or more secure authentication process. As a result of the user performing the authentication process, the additional or more secure authentication process, or a combination thereof, the terminal handler 101 can authenticate the user. The terminal handler 101 can then transmit an application programming interface (API) call to the first IoT service device 106a to cause the first IoT service device 106a to perform the requested function.

Although certain examples described herein relate to the use of mobile devices to access the IoT service devices 106a-h, in other examples, the devices 104a-c may additionally or alternatively include non-mobile devices (e.g., desktop computers, laptop computers, and the like). The non-mobile devices can also be capable of communicating with or accessing any of the IoT service devices 106a-h via the network 130.

Additionally, although eight IoT service devices are depicted in FIG. 1, any number of IoT service devices can be found in the IoT service device environment 100. Moreover, as illustrated in FIG. 1, a first subset of the IoT service devices 106a-f can be indoor IoT service devices located in the indoor area 116 and a second subset of the IoT service devices 106g-h can be outdoor IoT service devices located in the outdoor area 118. In some examples, the outdoor IoT service devices (106g and 106h) can be accessible to a user within a user vehicle 122.

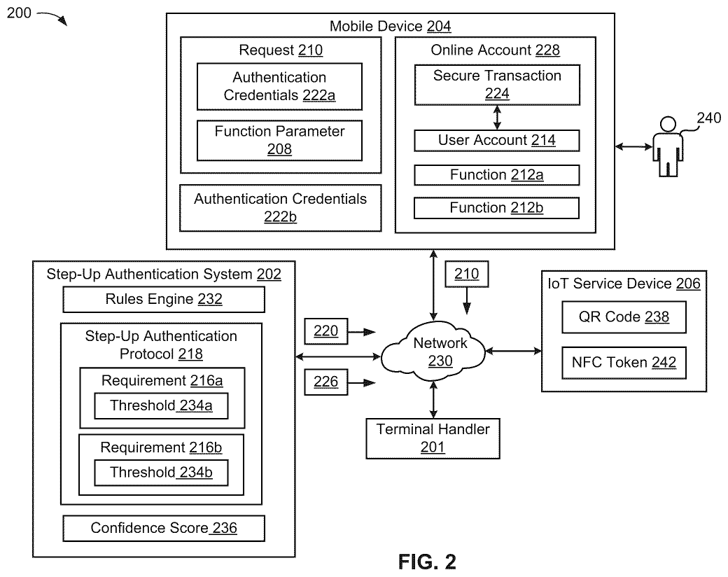

FIG. 2 is a block diagram of an example of a computing environment 200 for implementing a step-up authentication protocol 218 to facilitate secure transactions between IoT service devices and user accounts according to some embodiments of the present disclosure. In some examples, the computing environment 200 may be a distributed computing environment, such as a cloud computing system, an IoT computing platform, or a computing cluster, formed from one or more nodes (e.g., physical or virtual servers) that are in communication with one another via a network 230. Additionally, the computing environment 200 can include a step-up authentication system 202, which can be communicatively coupled to a mobile device 204 and an IoT service device 206 via the network 230. Examples of the network 230 can include a local area network (LAN) or the Internet. The computing environment 200 can be formed from a physical infrastructure that includes various network hardware, such as routers, hubs, bridges, switches, and firewalls. The physical infrastructure can also include one or more servers. The servers may provide backend support for a mobile application or a web interface for enabling a user 240 to interact with the IoT service device 206, a user account 214, or a combination thereof.

In an example, a user 240 may establish the user account 214 with a service provider. The user account 214 may be of any suitable type of account. For example, the service provider may be a bank and the user account 214 may be a deposit account. Separately from establishing the user account 214, the user 240 may register for an online account 228 with the service provider for use in monitoring and performing functions related to the underlying user account 214. The user 240 may then link the online account 228 to the underlying user account 214 hosted by the service provider. The user 240 can also register the online account 228 with the mobile device 204. Examples of the mobile device 204 can include a mobile phone, a laptop, a tablet, or a smart watch. Additionally, the online account 228 can be in communication with the IoT service device 206 such that the online account 228 can be used to access and control the IoT service device 206.

As a result of registering the online account 228 with the mobile device 204, the user 240 may obtain access to the online account 228 via the mobile device 204. For example, the user 240 may access the online account 228 via the mobile application or the web interface executing on the mobile device 204. In doing so, due to the online account 228 being in communication with the IoT service device 206, the user 240 can obtain access to functions 212a-b of the IoT service device 206 and can transmit requests for the IoT service device 206 to perform the functions 212a-b via the mobile device 204.

In some examples, the user 240 may obtain initial access to the online account 228, such as by accessing the mobile application on the mobile device 204. The user 240 may obtain the initial access by performing a first authentication process for the online account 228 via mobile application. For example, the user 240 can input first authentication credentials 222a (e.g., a username and password) associated with the online account 228, the user account 214, or combination thereof at the mobile application.

Additionally or alternatively, the IoT service device 206 can be associated with a Quick Response (QR) code 238 or a Near Field Communication (NFC) token 242. In one example, the QR code 238 can be scanned using the mobile device 204. The scanning of the QR code 238 can cause the user 240 to obtain the initial access to the online account 228 or may cause the mobile device 204 to prompt the user 240 to perform the first authentication process. For example, the step-up authentication system 202 may detect that the QR code 238 was scanned. In response, the step-up authentication system 202 can transmit a request to the mobile device 204 for the user 240 to perform a first authentication process via the mobile application. In another example, the user 240 may perform a tap gesture with the mobile device 204 to the NFC token 242. In particular, the user 240 may perform the tap gesture by placing the mobile device 204 or a card close (e.g., within four inches) to the NFC token 242. As a result of the tap gesture, communication between the mobile device 204 and the IoT service device 206 can be established. The step-up authentication system 202 may detect the tap gesture and transmit the request for the user 240 to perform the first authentication process.

In some examples, completion of the first authentication process can cause the mobile device 204 to automatically transmit a request for the IoT service device 206 to perform one or more of the functions 212a-b. In other examples, completion of the first authentication process can cause the step-up authentication system 202 to provide access for the mobile device 204 to the online account 228. The online account 228 can include the options for the functions 212a-b, which can be selected by the user 240 via the mobile device 204. Selection of an option for a function by the user 240 can cause the mobile device 204 to transmit a request for the IoT service device 206 to perform the function to the step-up authentication system 202.

In a particular example, the mobile device 204 may transmit a request 210 for the IoT service device 206 to perform a first function 212a to the step-up authentication system 202. In the particular example, the IoT service device 206 can be an ATM and the first function 212a can be for withdrawing funds from the user account 214. The request 210 can include a function parameter 208. For the first function 212a, the function parameter 208 can be an amount of funds to be withdrawn. The request 210 can also include the first authentication credentials 222a, which may have been used in the first authentication process and may be associated with the online account 228, the user account 214, the IoT service device 206, or a combination thereof.

The step-up authentication system 202 may then determine whether the request 210 satisfies one or more requirements 216a-b of a step-up authentication protocol 218. If the request 210 does not satisfy any of the requirements 216a-b, the step-up authentication system 202 can authenticate the user 240 based on the first authentication credentials 222a. Conversely, if the request 210 satisfies one or more of the requirements 216a-b, the step-up authentication system 202 can automatically execute the step-up authentication protocol 218. The step-up authentication protocol 218 can be a highly secure authentication process, in which the user 240 can be required to perform multiple types of authentication. The requirements 216a-b can define when to implement the step-up authentication protocol 218.

For example, a first requirement 216a can include a first threshold 234a, which can be a confidence score threshold. The confidence score threshold can depend on the function requested. For example, the first function 212a for withdrawing funds can be associated with a higher confidence score threshold than a second function 212b associated with transferring funds between user accounts, such as between the user account 214 and a savings account. The step-up authentication system 202 may execute the step-up authentication protocol 218 if a confidence score 236 for the request 210 is less than the first threshold 234a.

A rules engine 232 of the step-up authentication system 202 may determine the confidence score 236 for the request 210 based on the mobile device 204, a type of the first authentication credentials 222a, other suitable information included in the request 210 (e.g., the amount of funds to be withdrawn), account details of the user account 214 or the online account 228, or a combination thereof. For example, rules engine 232 can generate a higher confidence score if the mobile device 204 is registered with the user account 214. In another example, the rules engine 232 can generate a lower confidence score for the first authentication credentials 222a being a username and password rather than a face or fingerprint identification. In the particular example, the step-up authentication system 202 can determine that the confidence score 236 for the request 210 exceeds the first threshold 234a.

Additionally, a second requirement 216b can include a second threshold 234b, which can be a function parameter threshold. In the particular example, the second threshold 234b can be a threshold amount that can be withdrawn before the step-up authentication protocol 218 is implemented, such as five hundred dollars. The step-up authentication system 202 may execute the step-up authentication protocol 218 if the function parameter 208 in the request 210 is greater than the second threshold 234b. In the particular example, the function parameter 208 can be six hundred dollars. Therefore, the first requirement 216a associated with the first threshold 234a may not be satisfied and the second requirement 216b associated with the second threshold 234b may be satisfied.

After determining that the request 210 satisfies the second requirement 216b, the step-up authentication system 202 may transmit an authentication request 220 to the mobile device 204 for second authentication credentials 222b. The second authentication credentials 222b can be a one-time passcode (OTP), a fingerprint or face identification, a second username and second password, or another suitable type of authentication credential. The mobile device 204 can receive the authentication request 220 as, for example, a push notification. The user 240 may select the push notification and provide the second authentication credentials 222b via a second authentication process.

The step-up authentication system 202 may then authenticate the user 240 of the mobile device 204 based on the first authentication credentials 222a and the second authentication credentials 222b. For example, the step-up authentication system 202 may verify that the first authentication process and the second authentication process were successful, such as by verifying that the first authentication credentials 222a and the second authentication credentials 222b are valid for authenticating with the user account 214 or the online account 228.

In addition to authenticating the user 240, the step-up authentication system 202 may further authenticate the mobile device 204. To do so, the step-up authentication system 202 can determine that the mobile device 204 is proximate to the IoT service device 206. For example, the step-up authentication system 202 may detect a location of the mobile device 204, such as by accessing location services of the mobile device 204. Then, the step-up authentication system 202 may determine a distance between the location of the mobile device 204 and a location of the IoT service device 206. The location of the IoT service device 206 may be a secure location controlled by or otherwise associated with the service provider. The step-up authentication system 202 may further determine that the distance is less than a threshold distance to authenticate the mobile device 204.

Moreover, in some examples, the step-up authentication system 202 may detect that the mobile device 204 scanned the QR code 238 to determine that the mobile device 204 is proximate to the IoT service device 206. Additionally or alternatively, the step-up authentication system 202 may determine that the mobile device 204 is proximate the IoT service device 206 using the communication established between the mobile device 204 to the NFC token 242.

Additionally or alternatively, the step-up authentication system 202 may authenticate the mobile device 204 by verifying that the mobile device 204 is a registered device for the online account 228 and/or the user account 214. For example, the step-up authentication system 202 can generate a database. The database can include registered devices and corresponding user accounts. Therefore, the step-up authentication system 202 can, access the database to verify that the request 210 was received from the registered mobile device for the user account 214.

After authenticating the user 240 based on the first authentication credentials 222a and the second authentication credentials 222b, and, in some examples, further authenticating the mobile device 204, the step-up authentication system 202 can transmit an application programming interface (API) call 226 or otherwise communicate with the IoT service device 206. The API call 226 or other suitable communication method can cause the IoT service device 206 to perform the first function 212a. In the particular example, the API used by the step-up authentication system 202 can be an extension for financial services (XFS), such as XFS4. Therefore, the step-up authentication system 202 can communicate with and cause the IoT service device 206 to perform the first function 212a by transmitting the API call 226 via the API. In this way, the step-up authentication system 202 can automatically cause the IoT service device 206 to perform the first function 212a. The first function 212a can be a secure transaction 224 between the IoT service device 206 and the user account 214, such as a withdrawal of the amount of funds from the user account 214.

In some examples, the computing environment 200 can also include a terminal handler 201 for connecting, monitoring, and maintaining the computing environment 200. The terminal handler 201 can manage interactions between the step-up authentication system 202, the IoT service device 206, and the mobile device 204. For example, the terminal handler 201 can permit the mobile device 204 to transmit requests to the step-up authentication system 202. The terminal handler 201 may also be able to monitor the IoT service device 206. For example, the terminal handler 201 may monitor cash levels of the ATM.

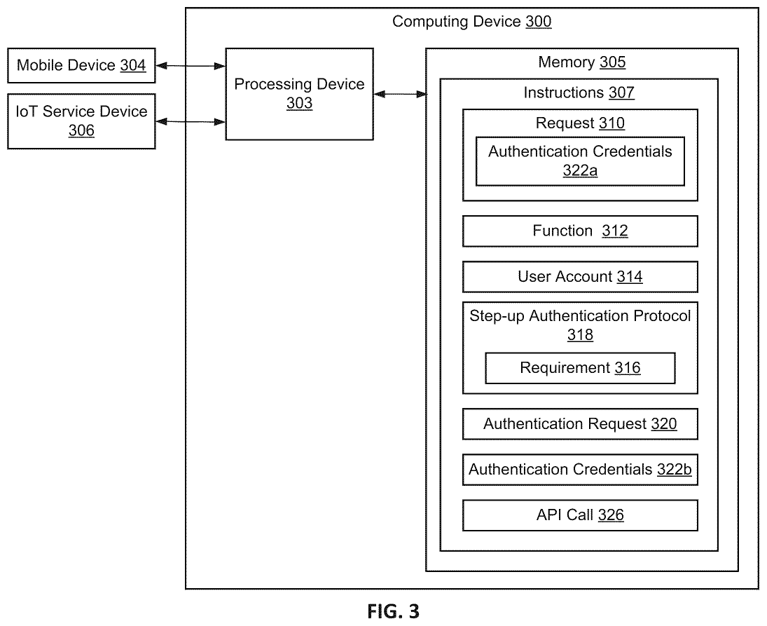

FIG. 3 is a block diagram of an example of a computing device 300 for implementing a step-up authentication protocol 318 to facilitate secure transactions between IoT service devices and user accounts according to some embodiments of the present disclosure. The components shown in FIG. 3, such as the processing device 303, the memory 305, and the like, may be integrated into a single structure such as within the single housing of the computing device 300. Alternatively, the components shown in FIG. 3 can be distributed from one another and in electrical communication with each other.

As shown, the computing device 300 includes the processing device 303 communicatively coupled to the memory 305. The processing device 303 can include one processor or multiple processors. Non-limiting examples of the processing device 303 include a Field-Programmable Gate Array (FPGA), an application specific integrated circuit (ASIC), a microprocessor, or any combination of these. The processing device 303 can execute instructions 307 stored in the memory 305 to perform operations. In some examples, the instructions 307 can include processor-specific instructions generated by a compiler or an interpreter from code written in any suitable computer-programming language, such as C, C++, C#, Python, or Java.

The memory 305 can include one memory device or multiple memory devices. The memory 305 can be non-volatile and may include any type of memory device that retains stored information when powered off. Non-limiting examples of the memory 305 include electrically erasable and programmable read-only memory (EEPROM), flash memory, or any other type of non-volatile memory. At least some of the memory 305 can include a non-transitory computer-readable medium from which the processing device 303 can read instructions 307. The non-transitory computer-readable medium can include electronic, optical, magnetic, or other storage devices capable of providing the processing device 303 with the instructions 307 or other program code. Non-limiting examples of the non-transitory computer-readable medium include magnetic disk(s), memory chip(s), RAM, an ASIC, or any other medium from which a computer processor can read instructions 307.

The processing device 303 can execute the instructions 307 to perform operations. For example, the processing device 303 can receive, from a mobile device 304, a request 310 to perform at least one function 312 of an Internet of Things (IoT) service device 306. The IoT service device 306 can be positioned in a location associated with a service provider and the request 310 can include first authentication credentials 322a for a user account 314 associated with the service provider. The processing device 303 can also determine that the request 310 satisfies at least one requirement 316 of the step-up authentication protocol 318. In response to determining that the request 310 satisfies the at least one requirement 316, the processing device 303 can transmit an authentication request 320 for second authentication credentials 322b to the mobile device 304. The processing device 303 can further receive, from the mobile device 304, the second authentication credentials 322b. The processing device 303 can then authenticate a user of the mobile device 304 based on the first authentication credentials 322a and the second authentication credentials 322b. Finally, in response to authenticating the user, the processing device 303 can transmit an application programming interface (API) call 326 to the IoT service device 306 to cause the IoT service device 306 to perform the at least one function 312. The at least one function 312 can involve a secure transaction between the IoT service device 306 and the user account 314.

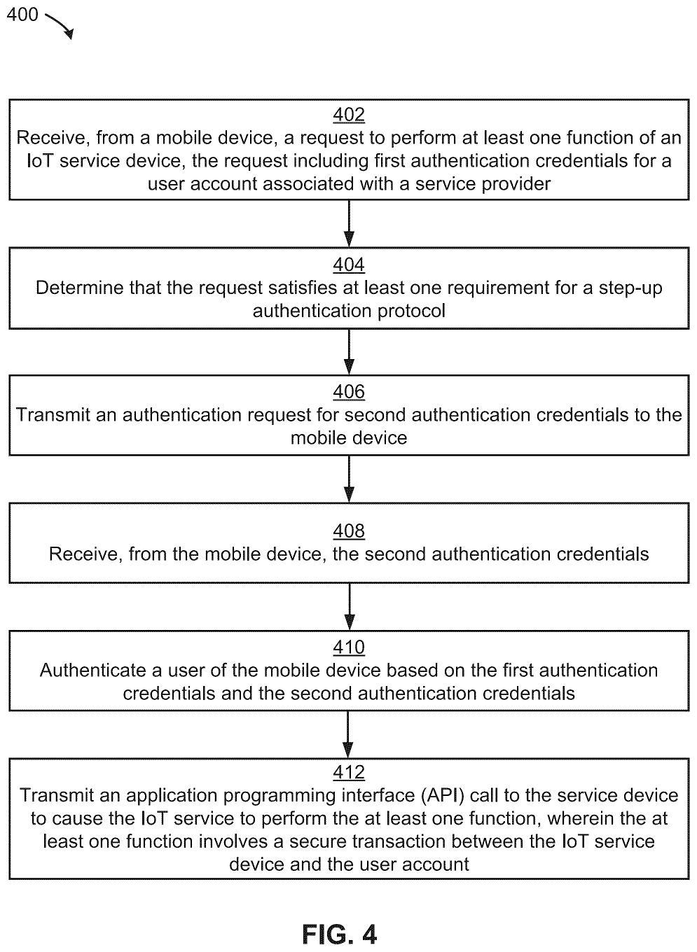

FIG. 4 is a flow chart of a process 400 for implementing a step-up authentication protocol to facilitate secure transactions between IoT service devices and user accounts according to some embodiments of the present disclosure. The process 400 of FIG. 4 can be implemented by the computing environment 102 of FIG. 1, the step-up authentication system 202 of FIG. 2, or the processing device 303 of FIG. 3, but other implementations are also possible. While FIG. 4 depicts a certain sequence of steps for illustrative purposes, other examples can involve more steps, fewer steps, different steps, or a different order of the steps depicted in FIG. 4. The steps of FIG. 4 are described below with reference to the components of FIGS. 2-3 described above.

At block 402, the processing device 303 can receive from a mobile device 304, a request 310 to perform at least one function 312 of an IoT service device 306. The request 310 can include first authentication credentials 322a for a user account 314 associated with a service provider. In an example, the service provider can be a financial institution, the user account 314 can be a savings account, and the first authentication credentials 322a can be a username and password. The IoT service device 306 can be positioned in a location associated with the service provider, such as a branch location for the financial institution. Additionally, the IoT service device 306 can be a teller cash recycler (TCR) and the function 312 requested can be for the TCR to count a cash deposit to be stored in the user account 314.

At block 404, the processing device 303 can determine that the request 310 satisfies at least one requirement 316 of a step-up authentication protocol 318. For example, the requirements 316 may indicate that the step-up authentication protocol 318 is to be executed for any transaction involving a savings account. Additionally or alternatively, the requirements 316 can include function parameter thresholds, confidence score thresholds, or other suitable requirements. Thus, for example, if a function parameter 208, such as the amount of cash for deposit, exceeds a corresponding function parameter threshold, the processing device 303 can determine that a requirement is satisfied. Additionally, if a confidence score 236 for the request 310 is less than a corresponding confidence score threshold, the processing device 303 may also determine that a requirement is satisfied.

At block 406, the processing device 303 can transmit an authentication request 320 for second authentication credentials 322b to the mobile device 304. The processing device 303 can transmit the authentication request 320 in response to the request 310 satisfying any of the requirements 316. Additionally, the processing device 303 can transmit the authentication request 320 as part of executing the step-up authentication protocol 318. The step-up authentication protocol 318 can be a highly secure authentication process, in which a user 240 can be required to perform multiple types of authentication. Thus, the authentication request 320 can be a request for a user 240 to provide second authentication credentials 322b that are different than first authentication credentials 322a.

At block 408, the processing device 303 can receive, from the mobile device 304, the second authentication credentials 322b. In the example, the user 240 may receive, at the mobile device 304, a one-time password (OTP) via a text, email, or other suitable communication method to a phone number, email address, or the like associated with the user account 314. The user 240 may then input the OTP at a mobile application associated with the service provider. As a result, the mobile device 304 can transmit the OTP to the processing device 303 as the second authentication credentials 322b.

At block 410, the processing device 303 can authenticate a user 240 of the mobile device 304 based on the first authentication credentials 322a and the second authentication credentials 322b. In the example, the processing device 303 can verify that the username and password are valid for authenticating with the user account 314. Additionally, the processing device 303 can verify that the OTP received from the mobile device 304 matches the OTP transmitted to the phone number, email, or the like. Thus, by verifying the authentication credentials 322a-b the processing device 303 can authenticate the user 240.

At block 412, the processing device 303 transmit an application programming interface (API) call 326 to the IoT service device 306 to cause the IoT service device 306 to perform the at least one function 312. The function 312 can involve a secure transaction 224 between the IoT service device 206 and the user account 314. In the example, the API call 326 can cause the IoT service device 306 to count the cash deposit and may further cause the IoT service device 306 to store the cash deposit in the user account 314. Therefore, the processing device 303 can cause the IoT service device 306 to perform the function 312 automatically in a secure manner and in response to the request 310 from the mobile device 304.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

What is claimed is:

1. A system comprising:
an Internet of Things (IoT) service device positioned in a location associated with a service provider;
a computing environment, the computing environment configured to control the IoT service device by:
receiving, from a mobile device, a request to perform at least one function of the IoT service device, the request including first authentication credentials for a user account associated with the service provider;
determining that the request satisfies at least one requirement of a step-up authentication protocol;
in response to determining that the request satisfies the at least one requirement, transmitting an authentication request for second authentication credentials to the mobile device;
receiving, from the mobile device, the second authentication credentials;
authenticating a user of the mobile device based on the first authentication credentials and the second authentication credentials; and
in response to authenticating the user, transmitting an application programming interface (API) call to the IoT service device to cause the IoT service device to perform the at least one function, wherein the at least one function involves a secure transaction between the IoT service device and the user account.

2. The system of claim 1, wherein the computing environment determines that the request satisfies the at least one requirement for the step-up authentication protocol by:
determining a confidence score for the request based on the mobile device and the first authentication credentials; and
determining that the confidence score is less than a confidence score threshold for the at least one function.

3. The system of claim 1, wherein the request to perform the at least one function of the IoT service device further comprises at least one function parameter, and wherein the computing environment determines that the request satisfies at least one requirement for a step-up authentication protocol comprises:
determining that the at least one function parameter exceeds a function parameter threshold.

4. The system of claim 1, wherein the computing environment further controls the IoT service device by:
authenticating the mobile device based on a distance between a location of the mobile device and the location associated with the service provider being less than a threshold distance.

5. The system of claim 1, further comprising:
a near-field communication (NFC) token or a Quick Response (QR) code associated with the IoT service device.

6. The system of claim 5, wherein the computing environment detects a tap gesture of the mobile device to the NFC token prior to receiving, from the mobile device, the request to perform the at least one function of the IoT service device.

7. The system of claim 5, wherein the computing environment detects the mobile device scanning the QR code prior to receiving, from the mobile device, the request to perform the at least one function of the IoT service device.

8. A computer-implemented method comprising:
receiving, from a mobile device, a request to perform at least one function of an Internet of Things (IoT) service device, the IoT service device positioned in a location associated with a service provider, and the request including first authentication credentials for a user account associated with the service provider;
determining that the request satisfies at least one requirement of a step-up authentication protocol;
in response to determining that the request satisfies the at least one requirement, transmitting an authentication request for second authentication credentials to the mobile device;
receiving, from the mobile device, the second authentication credentials;
authenticating a user of the mobile device based on the first authentication credentials and the second authentication credentials; and
in response to authenticating the user, transmitting an application programming interface (API) call to the IoT service device to cause the IoT service device to perform the at least one function, wherein the at least one function involves a secure transaction between the IoT service device and the user account.

9. The computer-implemented method of claim 8, further comprising determining that the request satisfies the at least one requirement for the step-up authentication protocol by:
determining a confidence score for the request based on the mobile device and the first authentication credentials; and
determining that the confidence score is less than a confidence score threshold for the at least one function.

10. The computer-implemented method of claim 8, wherein the request to perform at least one function of the IoT service device further comprises at least one function parameter, and wherein computer-implemented method further comprises determining that the request satisfies the at least one requirement for the step-up authentication protocol by
determining that the at least one function parameter exceeds a function parameter threshold.

11. The computer-implemented method of claim 8, further comprising:
authenticating the mobile device based on a distance between a location of the mobile device and the location associated with the service provider being less than a threshold distance.

12. The computer-implemented method of claim 9, wherein the IoT service device is associated with a near-field communication (NFC) token or with a Quick Response (QR) code.

13. The computer-implemented method of claim 12, further comprising:
detecting a tap gesture of the mobile device to the NFC token prior to receiving, from the mobile device, the request to perform the at least one function of the IoT service device.

14. The computer-implemented method of claim 12, further comprising:
detecting the mobile device scanning the QR code prior to receiving, from the mobile device, the request to perform the at least one function of the IoT service device.

15. A non-transitory computer-readable medium comprising instructions that are executable by a processing device for causing the processing device to perform operations comprising:
receiving, from a mobile device, a request to perform at least one function of an Internet of Things (IoT) service device, the IoT service device positioned in a location associated with a service provider, and the request including first authentication credentials for a user account associated with the service provider;
determining that the request satisfies at least one requirement for a step-up authentication protocol;
in response to determining that the request satisfies the at least one requirement, transmitting an authentication request for second authentication credentials to the mobile device;
receiving, from the mobile device, the second authentication credentials;
authenticating a user of the mobile device based on the first authentication credentials and the second authentication credentials; and
in response to authenticating the user, transmitting an application programming interface (API) call to the IoT service device to cause the IoT service device to perform the at least one function, wherein the at least one function involves a secure transaction between the IoT service device and the user account.

16. The non-transitory computer-readable medium of claim 15, further comprising instructions that are executable by the processing device for causing the processing device to determine that the request satisfies the at least one requirement for the step-up authentication protocol by:
determining a confidence score for the request based on the mobile device and the first authentication credentials; and
determining that the confidence score is less than a confidence score threshold for the at least one function.

17. The non-transitory computer-readable medium of claim 15, wherein the request to perform at least one function of the IoT service device further comprises at least one function parameter, and further comprising instructions that are executable by the processing device for causing the processing device to determine that the request satisfies the at least one requirement for the step-up authentication protocol by:
determining that the at least one function parameter exceeds a function parameter threshold.

18. The non-transitory computer-readable medium of claim 15, further comprising instructions that are executable by the processing device for causing the processing device to perform operations comprising:
authenticating the mobile device based on a distance between a location of the mobile device and the location associated with the service provider being less than a threshold distance.

19. The non-transitory computer-readable medium of claim 15, wherein the IoT service device is associated with a near-field communication (NFC) token or with a Quick Response (QR) code.

20. The non-transitory computer-readable medium of claim 19, further comprising instructions that are executable by a processing device for causing the processing device to detect a tap gesture of the mobile device to the NFC token prior to receiving, from the mobile device, the request to perform the at least one function of the IoT service device.
